(19) United States
(12) Patent Application Publication
(10) Pub. No.: US 2008/0189612 A1
(43) Pub. Date: Aug. 7, 2008

(54) USING UNIQUE HELP UTILITY IDENTIFIER AS PARAMETER IN APPLICATION TO FACILITATE EXTRACTION OF HELP TUTORIAL FROM LIBRARY

(75) Inventors: Guoxuan Zhang, San Diego, CA (US); Tom Lam, Chula Vista, CA (US); Tam Dao, San Marcos, CA (US)

Correspondence Address: ROGITZ & ASSOCIATES, 750 B STREET, SUITE 3120, SAN DIEGO, CA, 92101, US

(73) Assignees: Sony Corporation; Sony Electronics Inc.

(21) Appl. No.: 11/946,416

(22) Filed: Nov. 28, 2007

Related U.S. Application Data
(60) Provisional application No. 60/899,203, filed on Feb. 1, 2007.

(51) Int. Cl. G06F 3/00

(52) U.S. Cl. 715/709

(57) ABSTRACT

Plural guided help utilities are provided in a library and accessed using unique identifiers to guide a user in a “show me” mode or “do it” mode through help instructions.

This application claims priority from U.S. provisional application 60/899,203, filed Feb. 1, 2007.

### FIELD OF THE INVENTION

The present invention relates generally to using a help utility identifier as a parameter in a software application to facilitate extraction of a help utility from a library of help utilities.

### BACKGROUND OF THE INVENTION

Guided Help is an interactive help utility that is designed to be integrated into an operating system to guide a user through each step of a particular task, such as creating a user account or turning a firewall on and off. Guided Help topics take control of the screen user interface and, while performing a task, dim the entire UI except for the specific UI element being controlled.

Thus, unlike traditional help utilities that require users to stop what they're doing to read an explanation or set of instructions and then follow them, Guided Help performs the steps for the user, with the user viewing the text of the topic just like a conventional help topic. Guided Help gives the user the option of walking through a task step-by-step, so the user can complete it himself (in a so-called “Show Me” mode, or having the task be completed automatically, pausing only when a user must make a choice in the application UI (the so-called “Do It” mode.)

As understood herein, while Guided Help exists it has not yet been provided in the operating system for which it was intended. Furthermore, regardless of whether it is eventually provided, the present invention recognizes a need to provide Guided Help through software applications running on an underlying operating system to better provide application-specific tutorials to users of systems not necessarily envisioned by the operating system provider.

### SUMMARY OF THE INVENTION

A method includes generating at least one guided help utility for an associated software application to be run on a computer operating system. The help utility includes a “show me” option and a “do it” option. If the “show me” option is selected the help utility leads a user through a task step-by-step, allowing the user to complete a task for which help is sought. In contrast, if the “do it” option is selected a computer processor automatically executes the task, pausing only when the user must make a choice. The method also includes associating a unique identifier with the guided help utility to facilitate accessing the utility through the associated software application, and passing the unique identifier through as a parameter in the source code of the associated software application. The help utility is invoked in response to a user selection.

Plural guided help utilities can be generated, each having an associated software application and a unique identifier. The help utilities can be loaded into a library that in turn is loaded onto a user computer. When a user selects a particular “help” utility the identifier of the utility is used to retrieve the utility from the library.

As set forth further below, a non-limiting help utility may be a wireless local area network (LAN) help utility. In this case the method can include generating a “HelpPane” object that is declared when a user selection is made to access properties and attributes. The “HelpPane” object provides references to searching and navigating within a user interface window.

The help utility may be accessed by a user using a desktop “help and support” shortcut, or by using a general “help and support, all programs” button, or by selecting a “help and support” entry on an initially displayed “welcome center” menu.

In another aspect, a tangible computer readable medium is usable by a processor to execute logic that includes receiving a user command to access a help utility, and using a unique identifier of the help utility to retrieve the help utility from a library of help utilities stored on a user computer. An instance of the help utility retrieved from the library can then be instantiated.

In yet another aspect, a method for providing plural help utilities in a library of a user computer includes generating the help utilities, each having an associated software application to be run on an operating system of the user computer. One or more of the help utilities can include a “show me” option and a “do it” option. Unique identifiers are associated with respective help utilities to facilitate accessing a utility through its associated software application. Also, a unique identifier is passed through as a parameter in source code of the associated software application, and the help utility invoked in response to a user selection.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting system in accordance with present principles;

FIG. 2 is a flow chart of present logic; and

FIGS. 3-8 arc screen shots illustrating principles in accordance with disclosure herein.

### DETAILED DESCRIPTION OF THE PREFERRED EMBODIMENT

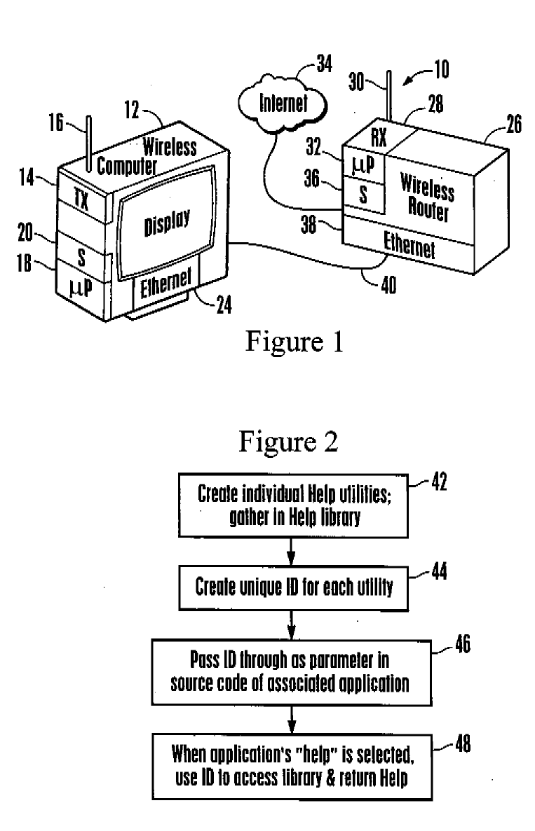

Referring initially to FIG. 1, a system is shown, generally designated 10, that includes a non-limiting wireless device 12 that may use the present help system and/or that may be used to undertake one or more steps in FIG. 2. The wireless device 12 can be but is not limited to a notebook computer with wireless communication capability, such as but not limited short-range infrared or radiofrequency (e.g., Bluetooth) wireless communication and/or longer range wireless communication capability such as GSM, code division multiple access (CDMA), wideband CDMA (W-CDMA), time division multiple access (TDMA), orthogonal frequency division multiplexing (OFDM), etc. Accordingly, the device 12 includes a wireless transceiver 14 with associated antenna 16, and the transceiver 14 communicates with a device processor 18 that may access a computer readable medium 20 such as volatile or non-volatile solid state storage, disk storage, tape storage, or other type of electronic storage medium or logic circuitry that typically can be executed by the processor 18 to, e.g., undertake the present logic.

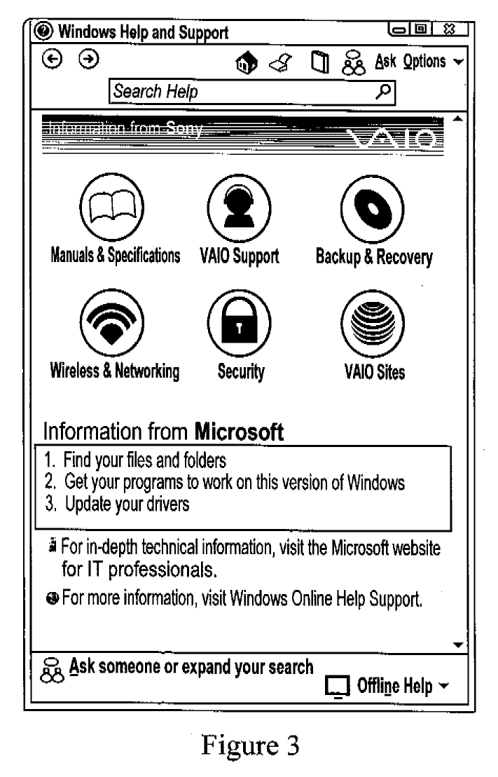

The processor 18 may control a display 22 such as a computer monitor that can present the screen shots shown in FIGS. 3-8. Also, the processor 18 can communicate with a wired communication interface 24 such as an Ethernet interface, it being understood that other types of wired interfaces such as universal serial bus (USB) interfaces may be used.

In the embodiment shown in FIG. 1, the wireless device 12 may communicate with a network node such as a wireless router 26. The wireless router 26 typically includes a wireless transceiver 28 with associated antenna 30 for wireless communication with the transceiver 14 of the wireless device 12. Also, the router 26 typically includes a router processor 32 that can communicate with the Internet 34. The router processor 32 can access a computer readable medium 36, as well as a wired communication interface such as an Ethernet interface 38. A wired communication path 40 may be established between the device 12 and router 26 by, e.g., an Ethernet cable.

Now referring to FIG. 2, commencing at block 42 individual guided help utilities are created for desired applications. The guided help utilities preferably provide both of the below-discussed “show me” and “do it automatically” options, and in one implementation may be generated using “Guided Help Studio” made by Microsoft Corp. The various help utilities so created can be stored in a library that is loaded onto the computer of FIG. 1 by the manufacturer of the computer.

Next, at block 44 a unique identifier is generated for each guided help tutorial so that it can be accessed through the associated software application's help menu. A help utility also may be accessed using a desktop “help and support” shortcut, or by using a general “help and support, all programs” button, or by selecting a “help and support” entry on an initially displayed “welcome center” menu that is discussed further below in reference to FIG. 3.

At block 46 the unique identifier for each help utility is passed through as a parameter in the source code of the software application with which the particular help utility is associated. Subsequently, as indicated by block 48 in FIG. 2, when a user selects a particular “help” utility the ID of the utility is used to retrieve the utility from the library.

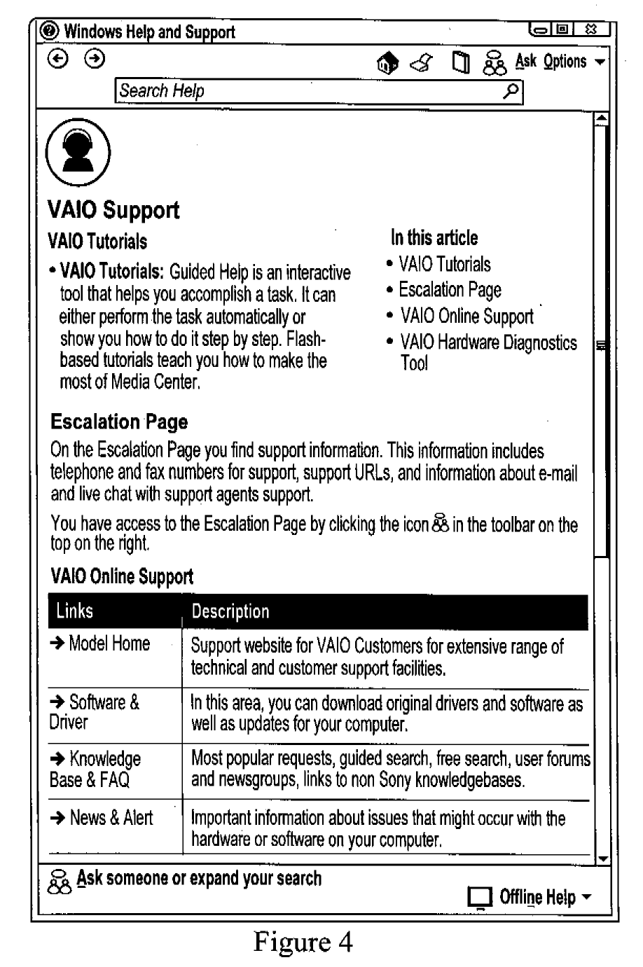

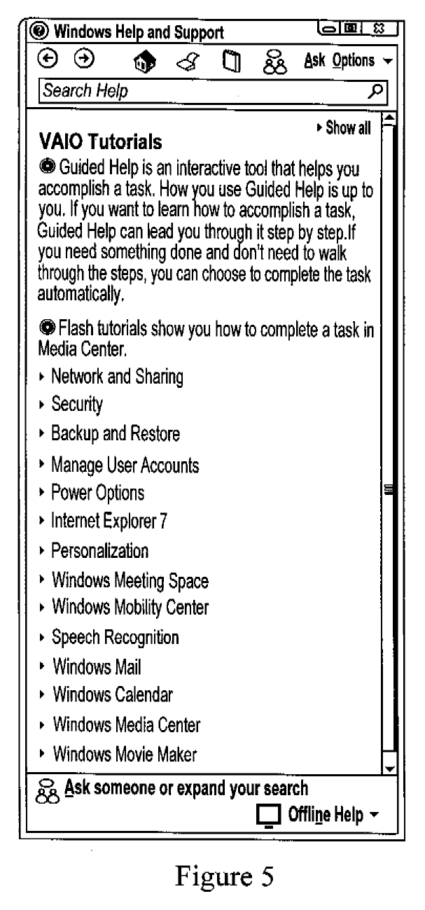

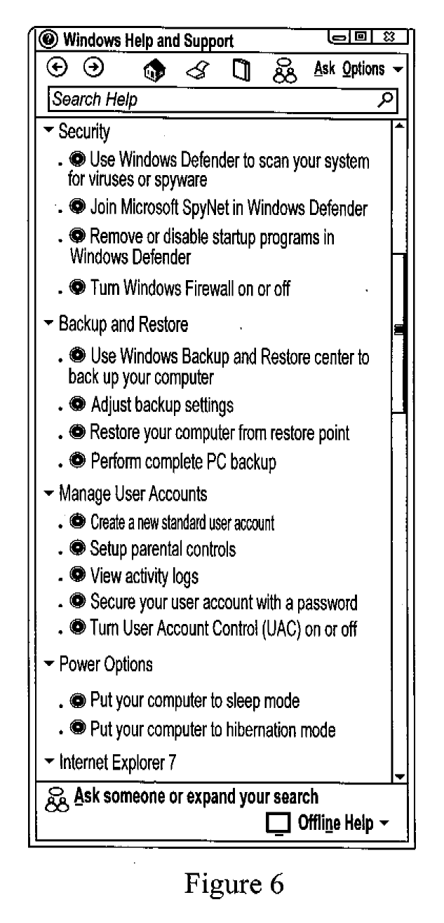

As intended herein, each guided help tutorial is a piece of help content with its pre-defined user interface and supplementary information and links to other relevant help content. A guided help tutorial can be invoked from, e.g., the “help and support” menu of FIG. 3, in which a user can select “VAIO support” (in which “VAIO” refers to a computer model) to invoke the lower-level menu of FIG. 4, showing various support choices. When the “VAIO tutorials” button is selected, a list of tutorials call e displayed as shown in FIG. 5, and when a user selects one, e.g., “security”, specific “help” activities related to the selection may be displayed as shown in FIG. 6.

When a help utility is selected, the computer user can decide whether he wants to be walked through a task step-by-step, completing the task himself (“show me” mode), or whether he wants the computer processor to automatically execute the task, pausing only when the user must make a choice in the application (“Do It” mode).

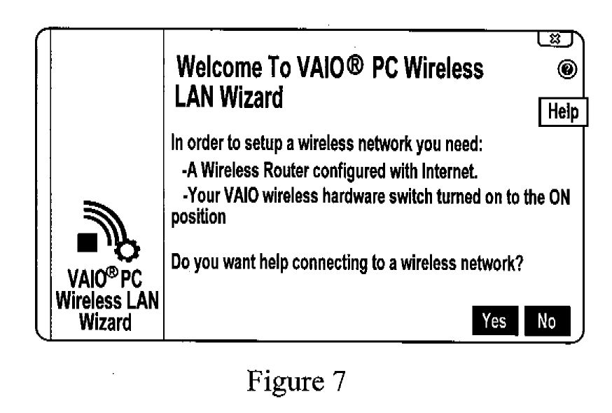

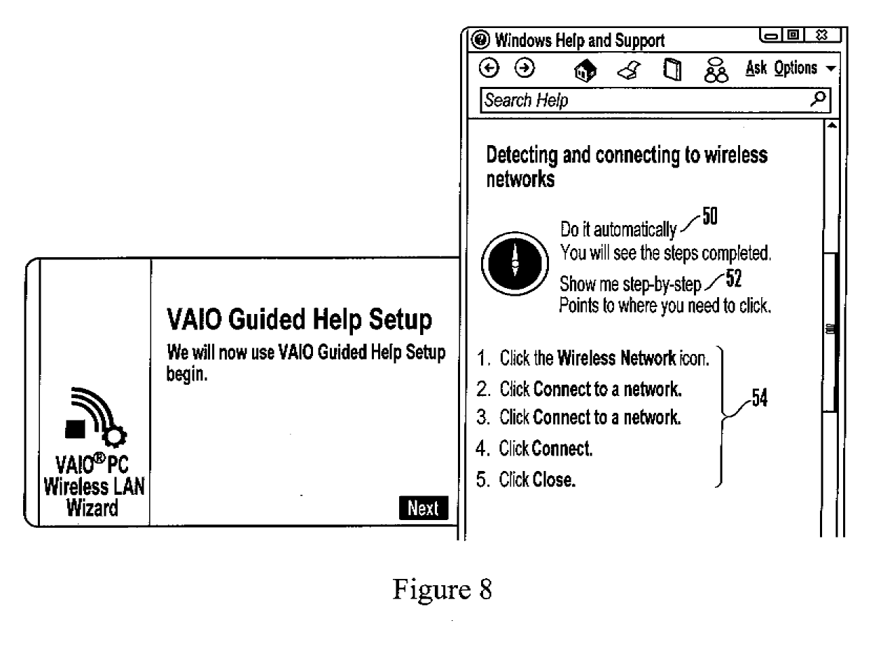

As an example, refer now to FIGS. 7 and 8. Assume the user has selected help in setting up wireless communication. The selection may be made by, e.g., selecting “network and sharing” in FIG. 5, to cause the screen shot of FIG. 7 to appear, it being understood that FIGS. 7 and 8 may be accessed through other menus such as a PC wireless LAN setup utility menu, in addition to or alternatively to FIG. 5. In any case, if the user selects “yes” to the question in FIG. 7 regarding whether help is desired, the screen of FIG. 8 appears, allowing (at 50) the user to select the “do it” mode and at 52 to select the “show me” mode. When “show me” is selected, help instructions 54 appear, individually highlighted if desired as the user moves through the instructions to indicate which action should be next.

To fuse the guided help together with the Wireless LAN Setup Wizard illustrated in FIGS. 7 and 8, an object referred to herein as a “HelpPane” object is declared when a selection is made from FIG. 7 to access the properties and attributes of the Help and Support Window shown in FIG. 8. This “HelpPane” object provides references to searching and navigating within the Help and Support Window of FIG. 8.

Non-limiting help tutorials that may be prepared and used as described above include:
Network and Sharing, including how to detect and connect to wireless networks, how to select between public and private location, how to connect to bluetooth devices, how to share data between bluetooth devices, and how to setup network sharing settings;
Security, including how to scan system for viruses or spyware, how to join a user group for computer security, how to remove or disable startup programs in a security program, and how to turn a firewall on or off;
Backup and Restore operations, including how to back up files on the computer, bow to adjust backup settings, how to restore the computer from a restore point, and how to perform complete computer backup;
Manage User Accounts, including how to create a new standard user account, how to view activity logs, how to secure a user account with a password, and how to turn a user account control (UAC) on or off;
Power Options, including how to put the computer in a sleep mode and how to put it in a hibernation mode;
Browser help, including how to add a page to a favorites list, how to change the home page, how to turn on and remove the menu bar, how to turn on the phishing filter, how to enable and disable a popup blocker, how to set a default search engine, and how to undertake tabbed browsing;
Personalization, including how to select a desktop background, how to select a screen saver, and how to select a theme
Online meeting help, including how to send an invitation file, how to join a meeting space session, how to set up people near the computer, how to set up a meeting space session, and how to share a document in an online meeting session;
help with computer mobility settings;
how to start speech recognition;
mail help, including how to setup an email account and how to send an email;
calendar help, including how to publish a calendar and how to create calendared tasks;
movie making help, including how to edit movie maker files, how to export a video to web-ready format, and how to import video, music or pictures to the computer's movie making application.

While the particular USING UNIQUE HELP UTILITY IDENTIFIER AS PARAMETER IN APPLICATION TO FACILITATE EXTRACTION OF HELP TUTORIAL FROM LIBRARY is herein shown and described in detail, it is to be understood that the subject matter which is encompassed by the present invention is limited only by the claims.

What is claimed is:

1. A method, comprising:
generating at least one guided help utility for an associated software application to be run on a computer operating system, the help utility including a “show me” option and a “do it” option, wherein if the “show me” option is selected the help utility leads a user through a task step-by-step, allowing the user to complete a task for which help is sought, and wherein if the “do it” option is selected a computer processor automatically executes the task, pausing only when the user must make a choice;
associating a unique identifier with the guided help utility to facilitate accessing the utility through the associated software application;
passing the unique identifier through as a parameter in the source code of the associated software application; and
invoking the help utility in response to a user selection.

2. The method of claim 1, comprising generating plural guided help utilities, each having an associated software application and unique identifier.

3. The method of claim 2, comprising loading the help utilities in a library and loading the library onto a user computer.

4. The method of claim 3, wherein when a user selects a particular “help” utility the identifier of the utility is used to retrieve the utility from the library.

5. The method of claim 1, wherein the help utility is a wireless local area network (LAN) help utility and the method includes generating a “HelpPane” object that is declared when a user selection is made to access properties and attributes, the “HelpPane” object providing references to searching and navigating within a user interface window.

6. The method of claim 1, wherein the help utility may be accessed by a user using a desktop “help and support” shortcut, or by using a general “help and support, all programs” button, or by selecting a “help and support” entry on an initially displayed “welcome center” menu.

7. A tangible computer readable medium usable by a processor to execute logic comprising:
receiving a user command to access a help utility;
using a unique identifier of the help utility, retrieving the help utility from a library of help utilities stored on a user computer; and
instantiating an instance of the help utility retrieved from the library.

8. The medium of claim 7, wherein the help utility includes a “show me” option and a “do it” option, wherein if the “show me” option is selected the help utility leads a user through a task step-by-step, allowing the user to complete a task for which help is sought, and wherein if the “do it” option is selected a computer processor automatically executes the task, pausing only when the user must make a choice.

9. The medium of claim 8, wherein the unique identifier is a parameter in source code of a software application associated with the help utility.

10. The medium of claim 9, wherein each of plural help utilities has an associated software application and associated unique identifier.

11. The medium of claim 10, wherein when a user selects a particular “help” utility the ID of the utility is used to retrieve the utility from the library.

12. The medium of claim 7, wherein the help utility is a wireless local area network (LAN) help utility and the method includes generating a “HelpPane” object that is declared when a user selection is made to access properties and attributes, the “HelpPane” object providing references to searching and navigating within a user interface window.

13. The medium of claim 12, wherein the help utility may be accessed by a user using a desktop “help” shortcut, or by using a general “help and support, all programs” button, or by selecting a “help” entry on an initially displayed “welcome center” menu.

14. A method for providing plural help utilities in a library of a user computer, comprising:
generating the help utilities, each having an associated software application to be run on an operating system of the user computer, at least one of the help utilities including a “show me” option and a “do it” option, wherein if the “show me” option is selected the help utility leads a user through a task step-by-step, allowing the user to complete a task for which help is sought, and wherein if the “do it” option is selected a computer processor automatically executes the task, pausing only when the user must make a choice;
associating unique identifiers with respective help utilities to facilitate accessing a utility through its associated software application;
passing a unique identifier through as a parameter in source code of the associated software application; and
invoking the help utility in response to a user selection.

15. The method of claim 14, wherein when a user selects a particular “help” utility the identifier of the utility is used to retrieve the utility from the library.

16. The method of claim 14, wherein the help utility is a wireless local area network (LAN) help utility and the method includes generating a “HelpPane” object that is declared when a user selection is made to access properties and attributes, the “HelpPane” object providing references to searching and navigating within a user interface window.

17. The method of claim 14, wherein the help utility may be accessed by a user using a desktop “help” shortcut, or by using a general “help and support, all programs” button, or by selecting a “help” entry on an initially displayed “welcome center” menu.
